(19) United States
(12) Patent Application Publication
(10) Pub. No.: US 2020/0182270 A1
(43) Pub. Date: Jun. 11, 2020

(54) HYDRAULIC TENSIONER HAVING A SLEEVE AND METHOD OF MANUFACTURING THE SAME

(71) Applicant: BorgWarner Inc., Auburn Hills, MI (US)

(72) Inventors: John B. Ludwick, Vestal, NY (US); Paul Freemantle, Lansing, NY (US)

(21) Appl. No.: 16/213,352

(22) Filed: Dec. 7, 2018

(51) Int. Cl. F15B 15/14; F16H 7/08; B21D 22/28

(52) U.S. Cl. CPC F15B 15/1428; F16H 2007/0812; B21D 22/28; F16H 7/08

(57) ABSTRACT

A hydraulic tensioner includes a housing defining a cavity configured to receive a fluid from a pressurized fluid source. The hydraulic tensioner also includes a piston disposed within the cavity and configured for movement between a retracted position and an extended position based on a pressure of the fluid. Additionally, the hydraulic tensioner includes a sleeve disposed within the cavity and having an inner surface and an outer surface spaced from the inner surface, the inner surface defining an interior aperture for receiving the piston. Moreover, the sleeve has a thickness of 2 mm or less between the inner surface and the outer surface.

### BACKGROUND OF THE INVENTION

### 1. Field of the Invention

The subject invention generally relates to a hydraulic tensioner for an engine system for a vehicle which also includes a vehicle engine.

### 2. Description of the Related Art

Conventional vehicles include a vehicle engine which may be coupled to a hydraulic tensioner. The hydraulic tensioner is configured to keep constant tension on chains or belts disposed within the vehicle engine. Conventional hydraulic tensioners are coupled to a pressurized fluid source and typically include a housing defining a cavity configured to receive a fluid from the pressurized fluid source and a piston disposed within the cavity configured to move based on a pressure of the fluid.

Many conventional hydraulic tensioners have a housing comprised of aluminum due to weight and cost concerns. Other components of the hydraulic tensioners are comprised of steel due to the strength needed during operation and to resist wear from moving components. However, these hydraulic tensioners suffer from difficulties in maintaining fluid flow rates due to variation in piston-to-housing clearances. More specifically, as the vehicle engine heats up, the hydraulic tensioner is heated and the aluminum housing expands at a faster rate than the steel piston, which may cause unsatisfactory clearances between the housing and the piston, causing issues with fluid flow rates through the hydraulic tensioner and a loss of performance at higher temperatures. To combat this issue, some hydraulic tensioners include a steel sleeve that is press-fit into the cavity of the housing such that the sleeve and the steel piston expand at the same rate during heating. However, steel press-fit sleeves are expensive and difficult to assemble and manufacture because press-fitting requires a particularly thick sleeve (e.g. a sleeve having a thickness of greater than 3 mm) to prevent bore distortion during assembly and subsequent piston binding. One example of a prior art hydraulic tensioner 9 having a thick sleeve is illustrated in FIG. 1A. As such, there remains a need for an improved hydraulic tensioner which prevents issues with fluid flow rates due to warming of the vehicle engine and improves assembly and manufacturing costs and processes.

### SUMMARY OF THE INVENTION AND ADVANTAGES

A hydraulic tensioner is disclosed herein. The hydraulic tensioner includes a housing defining a cavity configured to receive a fluid from a pressurized fluid source. The hydraulic tensioner also includes a piston disposed within the cavity and configured for movement between a retracted position and an extended position based on a pressure of the fluid. Additionally, the hydraulic tensioner includes a sleeve disposed within the cavity and having an inner surface and an outer surface spaced from the inner surface, the inner surface defining an interior aperture for receiving the piston. Moreover, the sleeve has a thickness of 2 mm or less between the inner surface and the outer surface.

Additionally, an engine system for a vehicle including the hydraulic tensioner is disclosed herein. The engine system also includes a vehicle engine. Finally, a method of manufacturing the hydraulic tensioner is disclosed herein. Having the sleeve with a thickness of 2 mm or less between the inner surface and the outer surface prevents issues with fluid flow rates due to thermal expansion and improves assembly and manufacturing costs.

### BRIEF DESCRIPTION OF THE DRAWINGS

Other advantages of the present invention will be readily appreciated, as the same becomes better understood by reference to the following detailed description when considered in connection with the accompanying drawings, wherein:

FIG. 1A is a cross-sectional view of a prior art hydraulic tensioner;

FIG. 1B is a cross-sectional view of a hydraulic tensioner having a sleeve according to the present invention;

FIG. 2 is a cross-sectional view of the hydraulic tensioner of FIG. 1B having components inside the sleeve removed;

FIG. 3 is a cross-sectional view of the hydraulic tensioner of FIG. 1B including the sleeve;

FIG. 4A is a cross-sectional view of the sleeve of FIG. 1B; and

FIG. 4B is an opposite side cross-sectional view of the sleeve of FIG. 4A.

### DETAILED DESCRIPTION OF THE INVENTION

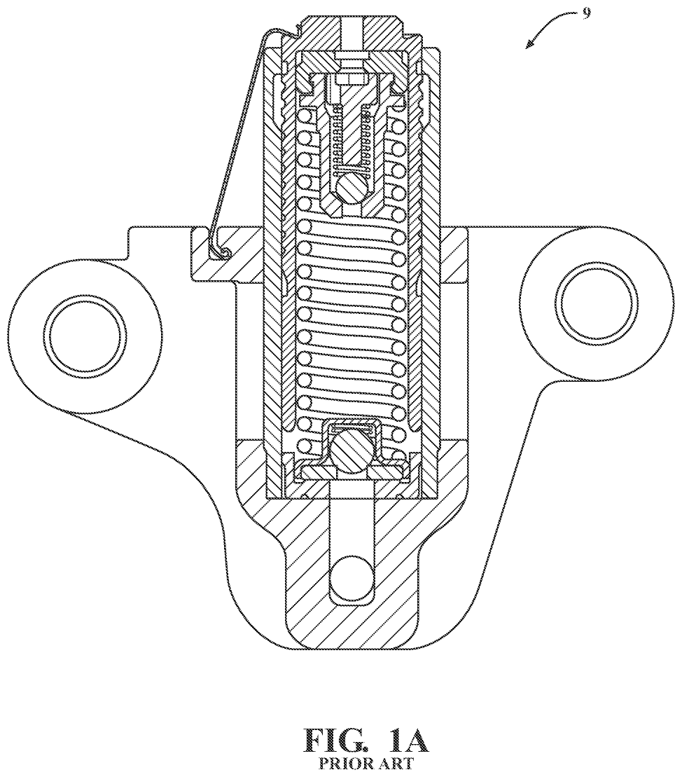

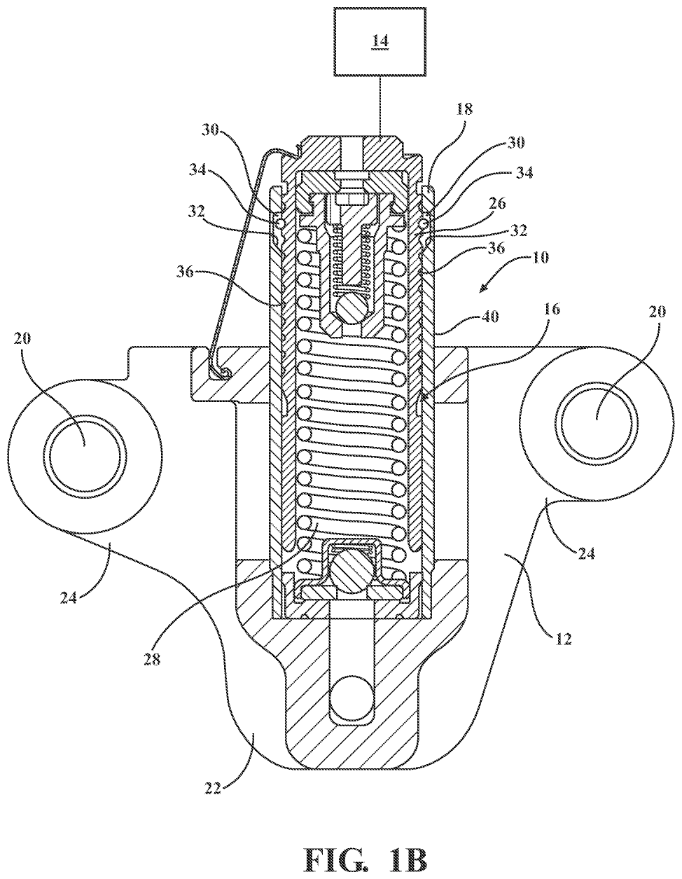

Referring now to the Figures, where like numerals are used to designate like structure unless otherwise indicated, a hydraulic tensioner according to the present invention is illustrated at 10 in FIGS. 1B-3. As illustrated herein, the hydraulic tensioner 10 and corresponding components are not necessarily drawn to scale. As illustrated in FIG. 1B, the hydraulic tensioner 10 includes a housing 12. The housing 12 of the hydraulic tensioner 10 may be coupled to a vehicle engine 14 of a vehicle. Moreover, the tensioner 10 may be configured to produce or maintain tension to various chains or belts within the vehicle engine 14. It is contemplated that the belts may include a timing chain or belt, a serpentine chain or belt, or any other chain or belt as known by one of ordinary skill in the art. It is also contemplated that the hydraulic tensioner 10 may be configured to produce or maintain tension or various other objects within or coupled to the vehicle engine 14 or other components of the vehicle, including, but not limited to, a vehicle transmission.

As best illustrated in FIG. 1, the housing 12 of the hydraulic tensioner 10 defines a cavity 16. The cavity 16 is configured to receive a fluid from a pressurized fluid source. The pressurized fluid source may be a pump or a reservoir. The fluid may be any type of fluid including, but not limited, to an oil, a transmission fluid, an engine fluid, water, and the like. As additionally illustrated in FIG. 1B, the cavity 16 may be cylindrical in shape. However, it is also contemplated that the cavity 16 may be of any other shape including, but not limited to, spherical, square, triangular, and the like. Moreover, various rotation prevention components or other features may be included in the cavity 16, if desired. In one embodiment, a connection portion 18 is included in the cavity 16. The connection portion 18 is configured to allow the housing 12 to be coupled with another component of the vehicle engine 14. It is also contemplated that multiple depressions and/or protrusions may be included in the cavity. Such depressions and protrusions are configured for filtering or storing the fluid and/or for coupling to the housing 12.

As also illustrated in the embodiment shown in FIG. 1B, it is contemplated that the housing 12 of the hydraulic tensioner 10 includes one or more bolt holes 20 configured to allow the housing 12 to be securely coupled to the vehicle engine 14 or elsewhere within the vehicle. In the embodiment shown in FIG. 1B, the housing 12 includes two bolt holes 20. However, any number of bolt holes 20 may be implemented to securely couple the hydraulic tensioner 10 within the vehicle. Additionally, it is contemplated that the housing 12 may be of any shape or size to allow the hydraulic tensioner 10 to be coupled to the vehicle engine 14 or elsewhere in the vehicle. In the embodiment illustrated in FIG. 1B, the housing 12 includes a central portion 22 which defines the cavity 16 and two opposite winged portions 24 which define the bolt holes 20. However, any number of shapes has been contemplated, including, but not limited to, triangular, cylindrical, square, and the like.

In the embodiment illustrated in FIG. 1B, the housing 12 is comprised of aluminum. However, it is also contemplated that the housing 12 may be comprised of any material including steel, stainless steel, plastic, and the like. Moreover, in the embodiment illustrated in FIG. 1B, the housing 12 is formed during an aluminum over-molding process, described in more detail below. However, it is also contemplated that the housing 12 may be formed by another process, including stamping, die casting, and the like.

The hydraulic tensioner 10 also includes a piston 26 disposed with the cavity 16. The piston 26 is configured for movement between a retracted position and an extended position based on a pressure of the fluid. Typically, the movement between the retracted position and the extended position is longitudinal. However, it is also contemplated that the movement may be latitudinal, rotational, and the like. As best illustrated in FIG. 1B, the piston 26 may be coupled to a biasing member 28. The biasing member 28 may be configured to bias the piston 26 in the retracted position. It is also contemplated that the biasing member 28 may be configured to bias the piston 26 in the extended position, if desired. In one embodiment, the biasing member 28 is a compression spring. However, it is also contemplated that the biasing member 28 may be another type including, but not limited to, a torsion spring, an extension spring, a cantilever spring and the like.

As best illustrated in FIG. 1B, the housing 12 may include an annular groove 30 having sidewalls 32. The annular groove 30 may be formed during the over-molding process of the housing 12, or may be machined at a later time. As illustrated in the embodiment shown in FIG. 1B, the hydraulic tensioner 10 may include a ratchet clip 34 fixed to an outer circumference of the piston 26 and selectively engageable with the annular groove 30. The sidewalls 32 may be configured for receiving the ratchet clip 34 and for limiting movement of the piston 26 between the retracted position and the extended position in response to the pressure of the fluid within the cavity 16 of the hydraulic tensioner 10. The ratchet clip 34 interacts with the sidewalls 32 to define longitudinal end limits of movement of the piston 26 while maintaining the desired predetermined pressure of the fluid.

Additionally, in one embodiment, the piston 26 may include a plurality of indents 36 longitudinally arranged along an external surface of the piston 26. In this embodiment, the ratchet clip 34 is selectively engageable within one of the plurality of indents 36 in sequential order along the external surface of the piston 26 as the piston 26 is moved toward the extended position. Movement of the piston 26 further toward the extended position moves the ratchet clip 34 into another indent 36 of the piston 26 extending the piston 26 to an incrementally expanded extended position.

In some embodiments, the hydraulic tensioner 10 may also include various other components including, but not limited to, one or more check valves to prevent backflow of the fluid, thereby preventing undesired pressure build up leading to undesired movement of the piston 26, and/or to allow intermittent lubrication of cavity 16; a cantilever spring configured to spring-load the piston 26 during shipment of the hydraulic tensioner 10; and a corresponding spring-receiving slot. The hydraulic tensioner 10 may also include additional elements disposed within the cavity 16 as desired by one of ordinary skill in the art.

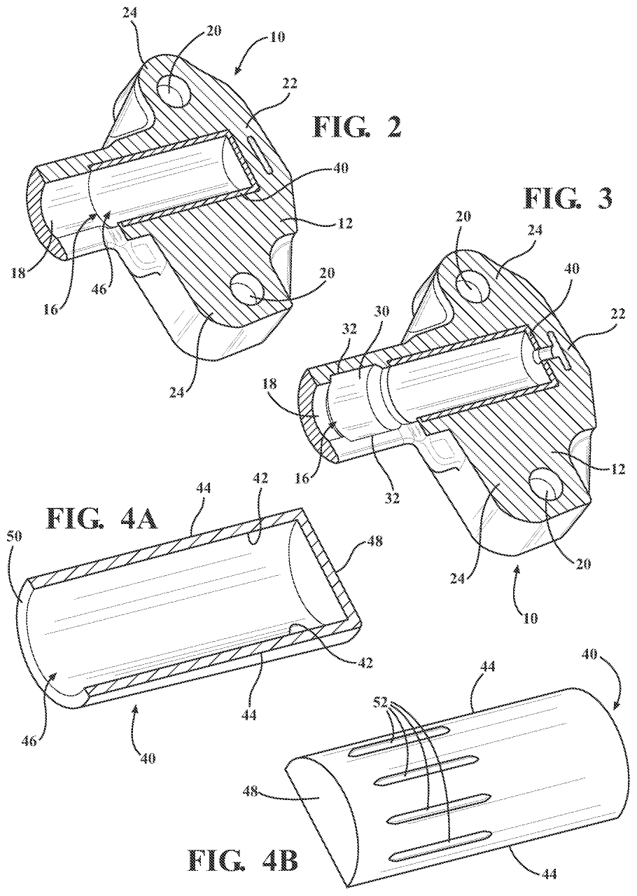

Referring now to FIGS. 2-4, the hydraulic tensioner 10 also includes a sleeve 40 disposed within the cavity 16 and having an inner surface 42 and an outer surface 44 spaced from the inner surface 42. The inner surface 42 defines an interior aperture 46 for receiving the piston 26. Generally, the sleeve 40 is shaped to be the same or a similar shape as the cavity 16 and is sized to house the piston 26 and the other internal components of the hydraulic tensioner 10. A thickness of the sleeve is defined between the inner surface 42 and the outer surface 44 is defined as a thickness of the sleeve 40. In one embodiment, the thickness of the sleeve 40 is 2 mm or less. In another embodiment, the thickness of the sleeve 40 is 1.5 mm or less. In yet another embodiment, the thickness of the sleeve 40 is 1.25 mm or less. In yet another embodiment, the thickness of the sleeve 40 is 1 mm or less. In yet another embodiment, the thickness of the sleeve 40 is 0.75 mm or less. In yet another embodiment, the thickness of the sleeve 40 is 0.5 mm or less. In yet another embodiment, the thickness of the sleeve 40 ranges from 2 mm to 0.1 mm.

In some embodiments, the thickness of the sleeve 40 may be defined at any location on the inner surface 42 and the outer surface 44 such that the thickness of the sleeve 40 may be the same throughout the entire length of the sleeve 40 or may vary throughout the length of the sleeve 40.

The sleeve 40 also includes a top surface 48 and a bottom surface 50 opposite the top surface 48. A length of the sleeve 40 is defined between the top surface 48 and the bottom surface 50. In one embodiment, the length of the sleeve 40 is less than 40 mm. In another embodiment, the length of the sleeve 40 is 37.5 mm or less. In yet another embodiment, the length of the sleeve 40 is 30 mm or less. In yet another embodiment, the length of the sleeve 40 is 28 mm or less. In yet another embodiment, the length of the sleeve 40 is 25 mm or less. In yet another embodiment, the length of the sleeve 40 ranges from 37.5 mm to 10 mm.

As best illustrated in FIGS. 3 and 4, the top surface 48 may extend over the entire interior aperture 46 to close the interior aperture 46 of the sleeve 40. However, it is also contemplated that the top surface 48 may not fully close the interior aperture 46 such that a portion of the top surface 48 is open. Moreover, in the embodiment illustrated in FIGS. 3 and 4, the bottom surface 50 does not close the interior aperture 46 such that the sleeve 40 is an open-ended cylinder. More specifically, the bottom surface 50 may not extend to close the interior aperture 46 to allow movement of the ratchet clip 34 and the piston 26 within the annular groove 30. In this embodiment, the sleeve 40 does not extend beyond the annular groove 30. In other embodiments, the bottom surface 50 may close the interior aperture 46, and the sleeve 40 will extend beyond the annular groove 30. In the embodiment where the sleeve 40 extends beyond the annular groove 30, the sleeve 40 includes a window therethrough to allow engagement of the piston 26 and the ratchet clip 34 with the annular groove 30.

In one embodiment, the sleeve 40 may be comprised of steel. However, it is also contemplated that the sleeve 40 may be comprised of another material, such as stainless steel, aluminum, plastic, and the like. In the embodiment illustrated in FIG. 1B, the sleeve 40 is comprised of the same material as the piston 26 and other internal components of the hydraulic tensioner 10. As such, in operation, when the hydraulic tensioner 10 heats up the piston 26, other internal components expand at the same rate as the sleeve 40, thus allowing clearances between the piston and the sleeve 40 to remain relatively the same.

As best illustrated in the embodiment shown in FIG. 4B, the outer surface 44 of the sleeve 40 may define at least one anti-rotating feature 52 such as a spline or other grooves. The at least one anti-rotating feature 52 is configured to prevent rotation of the sleeve 40 during machining or other processing of the hydraulic tensioner 10. It is contemplated that the at least one anti-rotating feature 52 may be further configured to engage a portion of the housing 12, such as the cavity 16, to prevent rotation. However, it is also contemplated that the at least one anti-rotating feature 52 may be configured to prevent rotation by any method as known by one of ordinary skill in the art including but not limited to knurled grooves, scalloped grooves, or multi-directional grooves. Moreover, it is contemplated that the anti-rotating features 52 may be present on the top surface 48 and/or the bottom surface 50 in addition to or alternatively to being present on the outer surface 44.

In one embodiment, the sleeve 40 is formed by deep-drawing such that a sheet is radially drawn into the sleeve 40. However, it is also contemplated that the sleeve 40 may be formed other ways including, but not limited to, stamping, casting, or other steel machining processes. The at least one anti-rotating feature 52 may be formed during the deep-drawing or other forming step or may be formed by machining once the sleeve 40 is formed.

Moreover, in one embodiment, the housing 12 is over-molded onto the outer surface 44 of the sleeve 40. The over-molding of the housing 12 onto the outer surface 44 of the sleeve 40 allows the sleeve 40 to be a standard shape and size and not be present in areas that require variation in size due to various customer requirements, such as in the annular groove 30 and/or the connection portion 18. Moreover, the over-molding process allows the sleeve 40 to be built directly into the hydraulic tensioner 10, which enables the thickness of the sleeve 40 to be minimal.

During manufacturing of the hydraulic tensioner 10, the deep drawing is performed on the sheet to form the sleeve 40 having a thickness of 2 mm or less between the inner surface 42 and the outer surface 44. Once the sleeve 40 is formed, the housing 12 is over-molded onto the outer surface 44 of the sleeve 40. The housing 12 and/or the sleeve 40 may then be machined to form the annular groove 30, the anti-rotating features 52, or other desired features, such as smoothness of the housing 12 and/or the sleeve 40, the connection portion 18, or the bolt holes 20. The hydraulic tensioner 10 may then be coupled to the vehicle engine 14 for operation of the hydraulic tensioner 10.

Having the sleeve 40 comprised of materials with the same expansion coefficient as the piston 26 and other internal components while having a thickness of 2 mm or less between the inner surface 42 and the outer surface 44 prevents issues with fluid flow rates by allowing the sleeve 40 and the piston 26 to expand and contract at the same rate during heating and cooling and also improves assembly and manufacturing costs. Additionally, over-molding the housing 12 onto the outer surface 44 of the sleeve 40 allows the sleeve 40 to have a thickness of 2 mm or less without failing during assembly of the hydraulic tensioner 10 because over-molding does not require the sleeve to be as thick (e.g. greater than 3 mm) as other assembly processes; for example, where the sleeve is press-fit. Moreover, over-molding the housing 12 onto the sleeve 40 allows the sleeve 40 to be a standard shape and size, as the sleeve 40 does not need to be present in areas which require shape and size variation due to customer requirements, such as in areas near the annular groove 30 and/or the connection portion 18 of the housing 12.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A hydraulic tensioner comprising:
a housing defining a cavity configured to receive a fluid from a pressurized fluid source;
a piston disposed within said cavity and configured for movement between a retracted position and an extended position based on a pressure of the fluid; and
a sleeve disposed within said cavity and having an inner surface and an outer surface spaced from said inner surface, said inner surface defining an interior aperture for receiving said piston;
wherein said sleeve has a thickness of 2 mm or less between said inner surface and said outer surface.

2. The hydraulic tensioner of claim 1, wherein said thickness is 1.25 mm or less.

3. The hydraulic tensioner of claim 1, wherein said thickness is 0.75 mm or less.

4. The hydraulic tensioner of claim 1, wherein said sleeve has a top surface and a bottom surface opposite said top surface and said sleeve has a length of 37.5 mm or less between said top surface and said bottom surface.

5. The hydraulic tensioner of claim 4, wherein said length is 30 mm or less.

6. The hydraulic tensioner of claim 1, wherein said housing is comprised of aluminum.

7. The hydraulic tensioner of claim 6, wherein said sleeve is comprised of steel.

8. The hydraulic tensioner of claim 1, wherein said outer surface of said sleeve includes at least one anti-rotating feature configured to prevent rotation of said sleeve during machining.

9. The hydraulic tensioner of claim 1, wherein said sleeve is deep-drawn.

10. The hydraulic tensioner of claim 9, wherein said housing is over-molded onto said sleeve.

11. The hydraulic tensioner of claim 7, wherein said sleeve is deep-drawn and said housing is over-molded onto said sleeve.

12. An engine system for a vehicle comprising:
a vehicle engine;
a hydraulic tensioner coupled to said vehicle engine, said hydraulic tensioner comprising:
a housing defining a cavity configured to receive a fluid from a pressurized fluid source;
a piston disposed within said cavity and configured for movement between a retracted position and an extended position based on a pressure of the fluid; and
a sleeve disposed within said cavity and having an inner surface and an outer surface spaced from said inner surface, said inner surface defining an interior aperture for receiving said piston;
wherein said sleeve has a thickness of 2 mm or less between said inner surface and said outer surface.

13. The hydraulic tensioner of claim 12, wherein said thickness is 1.25 mm or less.

14. The hydraulic tensioner of claim 12, wherein said sleeve has a top surface and a bottom surface opposite said top surface and said sleeve has a length of 37.5 mm or less between said top surface and said bottom surface.

15. The hydraulic tensioner of claim 14, wherein said length between said top surface and said bottom surface is 30 mm or less.

16. The hydraulic tensioner of claim 15, wherein said housing is comprised of aluminum.

17. The hydraulic tensioner of claim 16, wherein said sleeve is comprised of steel.

18. A method of manufacturing a hydraulic tensioner, the hydraulic tensioner comprising a housing defining a cavity configured to receive a fluid from a pressurized fluid source; a piston disposed within the cavity and configured for movement between a retracted position and an extended position based on a pressure of the fluid; and a sleeve disposed within the cavity and having an inner surface and an outer surface spaced from the inner surface, the inner surface defining an interior aperture for receiving the piston, said method comprising:
deep drawing a sheet to form the sleeve having a thickness of 2 mm or less between the inner surface and the outer surface;
over-molding the housing onto the outer surface of the sleeve; and
disposing the piston within the interior aperture of the sleeve.

19. The method of claim 18, further comprising the step of machining the housing to define at least one annular groove within the housing, wherein the step of machining the housing to form the at least one annular groove is performed after the step of over-molding the housing onto the outer surface of the sleeve.

20. The method of claim 18, wherein the sleeve is comprised of steel and the housing is comprised of aluminum.
